(19) United States
(12) Patent Application Publication
(10) Pub. No.: US 2026/0067242 A1
(43) Pub. Date: Mar. 5, 2026

(54) GAZE-ADAPTIVE ASSISTANCE FOR CONVERSATIONAL USER INTERFACES

(71) Applicant: CELLIGENCE INTERNATIONAL LLC, Guaynabo, PR (US)

(72) Inventors: Pavan AGARWAL, DORADO, PR (US); Gabriel Albors SANCHEZ, SAN JUAN, PR (US); Jonathan Ortiz RIVERA, SAN JUAN, PR (US)

(73) Assignee: CELLIGENCE INTERNATIONAL LLC, Guaynabo, PR (US)

(21) Appl. No.: 19/327,919

(22) Filed: Sep. 12, 2025

Related U.S. Application Data
(63) Continuation-in-part of application No. 19/182,453, filed on Apr. 17, 2025.
Application No. 19/182,453 is a continuation-in-part of application No. 18/135,703, filed on Apr. 17, 2023, now Pat. No. 12,393,433.
(60) Provisional application No. 63/332,205, filed on Apr. 18, 2022.

(51) Int. Cl. H04L 51/046; G06F 3/01; G06F 9/451

(52) U.S. Cl. CPC H04L 51/046; G06F 3/013; G06F 9/453

(57) ABSTRACT

Systems and methods are disclosed for gaze-adaptive assistance in a conversational user interface. During a chat session, an eye-tracking engine provides gaze samples that are mapped to rendered utterance regions of the interface. From the mapped samples, the system detects attention events—such as fixations and regressions—and maintains per-utterance reread and revisit counts within a sliding time window. When thresholds are satisfied, subject to confidence and false-positive gating, the system emits a contextual assistance prompt targeted to the implicated utterance. The prompt is presented inline as a chip or as an expanded card with actions including clarification, rephrase, example, step-by-step guidance, or additional detail, and subsequent assistant output is adapted based on user input. Calibration aligns gaze to screen space; a personalization component tunes thresholds and cool-downs from prior outcomes; and a fallback mode infers attention from pointer hover, scroll regressions, or text selection when camera access is unavailable. Raw video is discarded post-inference; only derived features are stored, and optional external content is retrieved through scoped connectors under consent.

### RELATED APPLICATIONS

This application a continuation-in-part of U.S. patent application Ser. No. 19/182,453, filed on Apr. 17, 2025, which is a continuation-in-part of U.S. patent application Ser. No. 18/135,703, filed on Apr. 17, 2023, which claims the benefit of U.S. Provisional Application No. 63/332,205 filed on Apr. 18, 2022, the contents of which are incorporated herein by reference in its entirety.

### FIELD OF INVENTION

The present embodiment relates to human-computer interaction for conversational systems, and more particularly to gaze-aware assistance that adapts an AI-driven chat interface based on eye-tracking or proxy “look-back” signals.

### BACKGROUND

Conventional chat systems lack awareness of user attention and comprehension. Users frequently reread a question or statement, or visually revisit content without responding. Existing UI telemetry (scroll and click logs) does not reliably capture rereads or silent confusion in-thread. Eye-tracking research exists for general UI studies, but there is a need for a chat-aware, utterance-level mechanism that transforms gaze signals into deterministic assistance behaviors while honoring privacy and latency constraints.

### SUMMARY

The present disclosure provides systems and methods for delivering gaze-adaptive assistance within a chat interface. During a conversation, the system receives gaze signals from a webcam-based estimator or eye-tracking device and maps user attention to rendered messages. From these observations, the system detects patterns such as rereads and revisits of a particular message and, when appropriate, presents a non-intrusive, message-anchored prompt offering help (e.g., clarification, rephrase, example, or step-by-step guidance). Prompts are shown inline or as an expanded card without disrupting the flow of the conversation, and users may dismiss, snooze, or opt out on a per-message basis. Calibration aligns gaze to screen space, and confidence/false-positive checks ensure prompts are emitted only when attention signals are reliable.

To improve performance over time, an adaptive learning component personalizes thresholds (e.g., reread/revisit counts, minimum dwell) and cool-down behavior based on prior accept/decline outcomes and task completion signals. When camera access is unavailable or confidence is low, the system gracefully falls back to look-back proxies—such as pointer hover dwell, scroll regressions, and text copy/select events—to infer attention and provide the same style of assistance. Privacy is built in, e.g., raw video frames used for on-device estimation are discarded post-inference, and only derived features (e.g., fixation spans and counters) are stored under tenant isolation and audited retention. When contextual examples or definitions are needed, the system may retrieve them through scoped connectors to approved external sources under user or tenant consent. These mechanisms enhance comprehension and reduce friction in chat-based work, while maintaining a seamless, personalized, and privacy-preserving user experience.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram illustrating an exemplary system architecture for gaze-aware conversational assistance, according to an implementation of the disclosure.

FIG. 2 is a user-interface diagram of a chat viewport, according to an implementation of the disclosure.

FIG. 3 is a pipeline diagram showing end-to-end data flow, according to an implementation of the disclosure.

FIG. 4 is a sate-machine/flow diagram illustrating event and counter handling, confidence gating and false-positive filtering, trigger thresholds, prompt emission, and post-trigger aftermath, according to an implementation of the disclosure.

FIGS. 5A-5B are ser-interface diagrams showing assistance presentation variants, according to an implementation of the disclosure.

FIGS. 6A-6C are calibration and mapping diagrams, according to an implementation of the disclosure.

FIG. 7 is calibration and mapping diagrams, according to an implementation of the disclosure.

FIG. 8 is diagram of fallback operation without gaze, according to an implementation of the disclosure.

FIG. 9 is privacy and compliance diagram comprising device, server, and external services, according to an implementation of the disclosure.

FIG. 10 illustrates an example computing system that may be used in implementing various features of embodiments of the disclosed technology.

Described herein are systems and methods for gaze-aware conversational assistance within a chat interface. During a session, the system acquires gaze samples from a webcam estimator or eye-tracking device, maps them to rendered utterance regions, and derives attention events (e.g., fixations, regressions) and counters (e.g., reread and revisit counts) in real time. When thresholds are met-subject to confidence and false-positive gating-the system emits an assistance signal that presents a contextual prompt localized to the implicated message (e.g., an inline chip or expanded card with actions such as rephrase, example, or step-by-step). A personalization component adapts dwell/threshold and cool-down parameters based on prior accept/decline behavior, while a fallback mode infers attention from pointer hover, scroll regression, or copy/select events when camera access is unavailable. Privacy controls ensure only derived features are stored; raw frames used for on-device estimation are discarded post-inference, and any external content retrieval (e.g., domain definitions/examples) occurs through scoped connectors under tenant consent. The details of some example embodiments of the systems and methods of the present disclosure are set forth in the description below. Other features, objects, and advantages of the disclosure will be apparent to one of skill in the art upon examination of the following description, drawings, examples and claims. It is intended that all such additional systems, methods, features, and advantages be included within this description, be within the scope of the present disclosure, and be protected by the accompanying claims.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments can be practiced without some of these details. Moreover, for the purpose of clarity, certain technical material that is understood in the related art has not been described in detail in order to avoid unnecessarily obscuring the disclosure. Furthermore, the disclosure, as illustrated and described herein, may be practiced in the absence of an element that is not specifically disclosed herein.

The present embodiment relates to a system and method for gaze-adaptive assistance within a conversational user interface. The disclosed system integrates eye-tracking (or privacy-preserving proxy signals) with chat-aware inference to determine when a user is rereading a displayed statement or revisiting a question without responding. Gaze samples are mapped to utterance regions rendered in the chat, enabling the system to detect fixations, regressions, and dwell patterns indicative of confusion or uncertainty. Upon detection, the system delivers non-intrusive assistance prompts—such as clarify, rephrase, example, step-by-step, or more detail—and adapts subsequent assistant output based on the user's selection. Thresholds are personalized per user, while privacy controls support on-device inference and storage of derived features (e.g., fixation spans, reread/revisit counters) rather than raw video frames.

### Conventional System Limitations

Traditional chat systems are attention-blind: they infer comprehension primarily from coarse telemetry (e.g., idle timers, scrolling, or message delays) that cannot distinguish between a quick skim and a true reread of a specific utterance. Existing eye-tracking solutions, where present, are typically used for page-level analytics and do not align gaze to the granular, per-utterance structure of chat or translate attention signals into deterministic, in-thread assistance. Heuristic “help” features often trigger after arbitrary inactivity thresholds, producing false positives and interrupting users who are simply thinking. Moreover, many camera-based approaches stream raw frames to servers, raising latency and privacy concerns, provide no confidence gating for noisy samples, and lack fallback mechanisms when a camera is unavailable or disabled. As a result, users receive either no help when it is needed or intrusive help when it is not, and systems fail to learn from repeated patterns of confusion over time.

### Technical Improvements of the Present Disclosure

The present embodiment introduces several technical improvements. A gaze-UI mapper aligns time-stamped gaze samples to DOM/layout bounding boxes for each utterance, enabling computation of fixations, regressions, and dwell metrics within sliding windows tied to the chat flow. A confusion detector maintains per-utterance reread and revisit counters and triggers a targeted assistance prompt only when confidence-gated conditions are met, reducing false positives. A personalization model adapts thresholds (e.g., counts, dwell cutoffs, cool-downs) from a population prior to a per-user profile based on historical accept/decline outcomes and task completion. A privacy & consent module supports on-device estimation and limits data retention to derived features, thereby reducing bandwidth and improving responsiveness. When gaze is unavailable, look-back proxies (pointer hover dwell, scroll regressions, selection/copy events) provide a functionally similar path to assistance. These mechanisms produce deterministic UI adaptations that improve human-computer interaction fidelity, accessibility, and comprehension in chat-based environments while honoring privacy constraints.

The following figure provides a high-level overview of the system architecture illustrating key modules and data flows between user devices and the server.

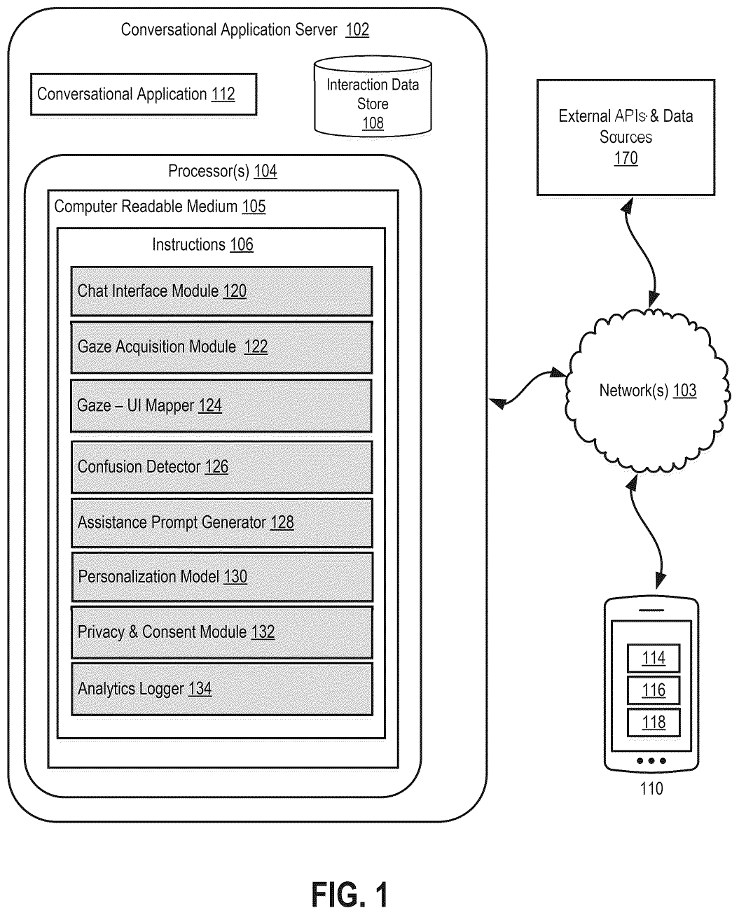

FIG. 1 is a block diagram illustrating an exemplary system architecture for gaze-adaptive assistance in a conversational user interface, according to a present embodiment. System 100 includes a conversational application server 102 coupled via network(s) 103 to one or more client devices 110 (illustrated as user device 114). The server 102 includes processor(s) 104, a computer-readable medium 105 storing instructions 106, an interaction data store 108, and a conversational application 112. The instructions 106 configure functional modules comprising: chat interface module 120, gaze acquisition module 122, gaze-UI mapper 124, confusion detector 126, assistance prompt generator 128, personalization model 130, privacy & consent module 132, and analytics logger 134. The system may further communicate with external APIs and data sources 170 via the network(s) 103 to retrieve domain content and context used in assistance prompts. The client devices 110 (e.g., smartphone, tablet, or desktop) execute a user-facing interface to interact with the conversational application 112 and may include a camera 116 and/or an optional eye-tracking device 118 (e.g., IR bar or dedicated tracker). In some embodiments, the gaze acquisition module 122 receives gaze samples generated on-device from the camera 116 via a webcam-based estimator, from the external eye-tracking device 118, or from a combination thereof.

As used herein, unless the context indicates otherwise: utterance means a discrete assistant or user message rendered in the chat interface; utterance region means a UI bounding box (and, in some embodiments, time-aligned token spans) corresponding to a rendered utterance; fixation means a contiguous interval during which gaze velocity and/or dispersion remains below a threshold; regression means a saccade from a later utterance region to an earlier utterance region within the same thread; reread count means a number of detected passes over an utterance region that exceed a fixation threshold; revisit count means a number of returns to a displayed question region without an intervening user response; confidence score means a tracker-provided or model-derived probability that a gaze sample or fixation is valid; and look-back proxies means non-gaze indicators of attention such as pointer dwell, pointer hover over an utterance region, or scroll regressions.

Unless stated otherwise, detection thresholds (e.g., fixation velocity/dispersion cutoffs, time-window lengths, confidence minima) are implementation-dependent and may be static, configurable, or learned per user. References to “gaze” encompass estimated gaze vectors produced by webcam-based estimators or dedicated eye-tracking devices, and may include head-pose compensation. References to a “question” region include assistant prompts that request a response (e.g., a clarifying question) and user-posed questions.

Hardware processor 104 may be one or more central processing units (CPUs), semiconductor-based microprocessors, and/or other hardware devices suitable for retrieval and execution of instructions stored in computer readable medium 105. Processor 104 may fetch, decode, and execute instructions 106, to control processes or operations for automatically categorizing tasks and assigning color. As an alternative or in addition to retrieving and executing instructions, hardware processor 104 may include one or more electronic circuits that include electronic components for performing the functionality of one or more instructions, such as a field programmable gate array (FPGA), application specific integrated circuit (ASIC), or other electronic circuits.

A computer readable storage medium, such as machine-readable storage medium 105 may be any electronic, magnetic, optical, or other physical storage device that contains or stores executable instructions. Thus, computer readable storage medium 105 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 105 may be a non-transitory storage medium, where the term “non-transitory” does not encompass transitory propagating signals. As described in detail below, machine-readable storage medium 105 may be encoded with executable instructions, for example, instructions 106.

The disclosed system operates within a modular, service-oriented architecture designed to support scalable, gaze-adaptive assistance in a conversational user interface. FIG. 1 provides a high-level system overview, showing key functional modules and data flows between client devices and the server.

In an exemplary implementation, the system includes a conversational application server 102 configured to facilitate chat interactions while ingesting attention signals and delivering context-aware assistance. The server 102 executes a conversational application 112 that orchestrates message flow, manages user preferences (including opt-in for gaze features), and invokes gaze processing and assistance modules in real time. The server comprises one or more processors 104 and a computer-readable medium 105 that stores instructions 106 executable by the processors. These instructions include a chat interface module 120 configured to render assistant/user utterances, collect user inputs, maintain utterance regions (e.g., bounding boxes and token spans), and expose interface controls for assistance prompts and accessibility settings.

In the following sections, each module is described in further detail with reference to specific functions, workflows, and interface elements.

A gaze acquisition module 122 is configured to receive time-stamped gaze samples and per-sample confidence values generated from a camera 116 via a webcam-based estimator and/or from an optional eye-tracking device 118 (e.g., IR tracker). In some embodiments, estimation is performed on-device to reduce latency and bandwidth. A gaze-UI mapper 124 associates gaze samples with utterance regions using DOM/layout hit-testing and may map to token-level spans for long messages. A confusion detector 126 segments samples into fixations and saccades, identifies regressions to earlier utterances, and maintains per-utterance reread and revisit counters within sliding windows. Triggers are confidence-gated and may incorporate false-positive filtering (e.g., blink rate, dispersion). Upon a threshold breach, an assistance prompt generator 128 produces non-intrusive, in-thread prompts (e.g., clarify, rephrase, example, step-by-step, more detail) with cool-down controls to prevent prompt fatigue. A personalization model 130 adapts thresholds (counts, dwell cutoffs, cool-downs) from a population prior to a per-user profile using historical accept/decline events, response latency, and task completion. A privacy & consent module 132 manages explicit user consent, child-account restrictions, and data minimization; in preferred embodiments the system stores only derived features (e.g., fixation spans, reread/revisit counters) and discards raw video frames post-inference. An analytics logger 134 records derived features and outcomes for A/B evaluation and threshold tuning. When gaze signals are unavailable or below confidence, the system may employ look-back proxies (e.g., pointer hover dwell within an utterance region, scroll regressions, selection/copy events) to provide functionally similar assistance behavior.

User interaction with the system occurs via one or more client devices 110, which may include smartphones, tablets, or desktop clients equipped with communication software. Each client device 110 may include a display, a network interface, a user-facing interface 114, and one or both of camera 116 and eye-tracking device 118. Devices connect to the conversational application server 102 over one or more networks 103 (e.g., the Internet or cellular data networks). In some implementations, the server 102 also accesses external APIs and data sources 170 to augment assistance content (e.g., definitions/examples from a knowledge base, domain-specific guidance, enterprise context) or to integrate with collaboration platforms (e.g., Zoom, WhatsApp, enterprise messaging). Integrations are governed by the privacy & consent module 132 and may be read-only or bidirectional.

In some embodiments, the system is deployed in a cloud environment with modular services exposed via secured APIs, enabling horizontal scalability, tenant isolation, and third-party integration while preserving on-device inference options for privacy and latency.

The system further includes an interaction data store 108, which serves as a centralized repository for contextual, UI, and user-specific data used by the conversational application 112. In a present embodiment, the interaction data store 108 maintains: (i) utterance metadata (e.g., bounding boxes, token spans, timestamps) used by the gaze-UI mapper 124; (ii) derived attention features written by the confusion detector 126 (e.g., fixation spans, reread/revisit counters, confidence summaries, cool-down state); (iii) personalization profiles consumed and updated by the personalization model 130 (e.g., per-user thresholds, dwell cutoffs, acceptance/decline history, task-completion metrics); and (iv) assistance artifacts retrieved by the assistance prompt generator 128 (e.g., templates, domain examples, definitions, accessibility preferences). The privacy & consent module 132 governs read/write access to the interaction data store 108 and enforces data-minimization policies: in preferred embodiments the system persists only derived features and prompt outcomes, while raw video frames and high-frequency gaze samples are processed on-device and discarded post-inference unless a user explicitly opts in to short-lived diagnostic capture. The interaction data store 108 may also cache selected materials obtained from external APIs and data sources 170 (e.g., domain glossaries or knowledge-base snippets) for low-latency assistance generation, subject to tenant and user consent. The interaction data store 108 may be maintained within the conversational application server 102 or distributed across a cloud infrastructure with tenant isolation, encryption at rest, and edge caches to support scalable access and real-time updates across devices and sessions. Cached materials are limited to minimally necessary, non-sensitive extracts with tenant scoping and a time-to-live; raw gaze/video data are never cached in the interaction data store 108.

User interaction with the system occurs via one or more client computing devices 110, which may include smartphones, tablets, or desktop clients equipped with communication software. Each client computing device 110 includes a display, a network interface, and a user-facing interface 114 for interacting with the conversational application 112. In some embodiments, the client computing device 110 further includes a camera 116 and/or an optional eye-tracking device 118 (e.g., IR bar or dedicated tracker) configured to supply gaze samples to the gaze acquisition module 122 subject to user consent.

In some embodiments, the system may be accessed through standard web browsers or existing messaging platforms, enabling compatibility with a wide range of client computing devices without requiring specialized software installation. The client computing device 110 may interact with the conversational application server 102 via a dedicated mobile application, an embedded widget, or third-party chat interfaces, depending on deployment context. When accessed via a browser or third-party platform, on-device webcam-based gaze estimation may run in a sandboxed environment; if camera permissions are denied or unavailable, the system employs look-back proxies (e.g., pointer hover dwell, scroll regressions, selection/copy events) to maintain assistance behavior. This design allows gaze-adaptive prompts and accessibility controls to be seamlessly integrated into existing communication workflows, minimizing user friction and ensuring broad cross-platform accessibility.

In some embodiments, the system may access external APIs and data sources 170 to augment assistance content and context. These third-party resources may include domain-specific knowledge bases, glossaries, help centers, documentation repositories, or enterprise systems (e.g., CRM, ticketing) that provide examples, definitions, or task-specific guidance retrieved by the assistance prompt generator 128. Integration with external messaging platforms, such as Zoom, WhatsApp, or enterprise collaboration tools, may be facilitated via API-level connections, enabling users to benefit from gaze-adaptive assistance even when operating outside of the native chat interface. Access to external APIs is governed by the privacy & consent module 132, least-privilege authentication, and data-minimization policies; in preferred embodiments, only prompt context and derived features (e.g., fixation spans, reread/revisit counters) are exchanged, and raw video or high-frequency gaze samples are not transmitted.

In a present embodiment, the chat interface module 120 renders assistant and user utterances with associated utterance regions (bounding boxes and, in some cases, token spans), exposes hit-testing metadata to downstream modules, and collects user inputs (text, taps/clicks, selections). The module supports virtualization for long threads, timestamping, threading, and accessibility controls (font size, contrast, read-aloud). It publishes layout updates (e.g., region positions) to the gaze-UI mapper 124 and event signals (e.g., user response posted, scroll) to the confusion detector 126.

The gaze acquisition module 122 receives time-stamped gaze samples and per-sample confidence scores produced by (i) an on-device webcam estimator using eye-landmarks/head-pose, and/or (ii) a dedicated eye-tracking device 118 (e.g., IR tracker). Typical sampling rates range from about 30-120 Hz; lower rates are upsampled with interpolation when appropriate. In preferred embodiments, raw video frames are processed on-device and discarded post-inference; only derived gaze samples and confidence values are emitted upstream, subject to the privacy & consent module 132.

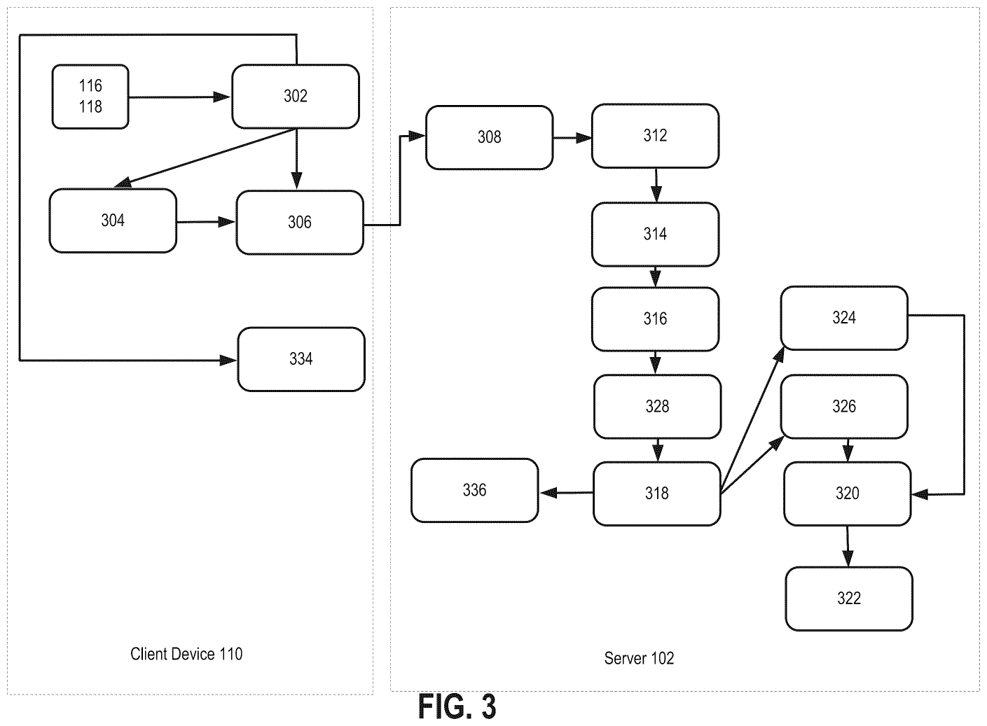

The gaze-UI mapper 124 associates gaze coordinates with utterance regions via DOM/layout hit-testing, applying smoothing and calibration transforms (e.g., homography adjusted by head-pose) to compensate for parallax and device DPI. For long messages, the mapper may align samples to token-range spans to distinguish rereads of different portions. The mapper emits region-aligned streams to the confusion detector 126 and updates mappings when layout changes occur (e.g., window resize, new messages), as described with reference to FIG. 3.

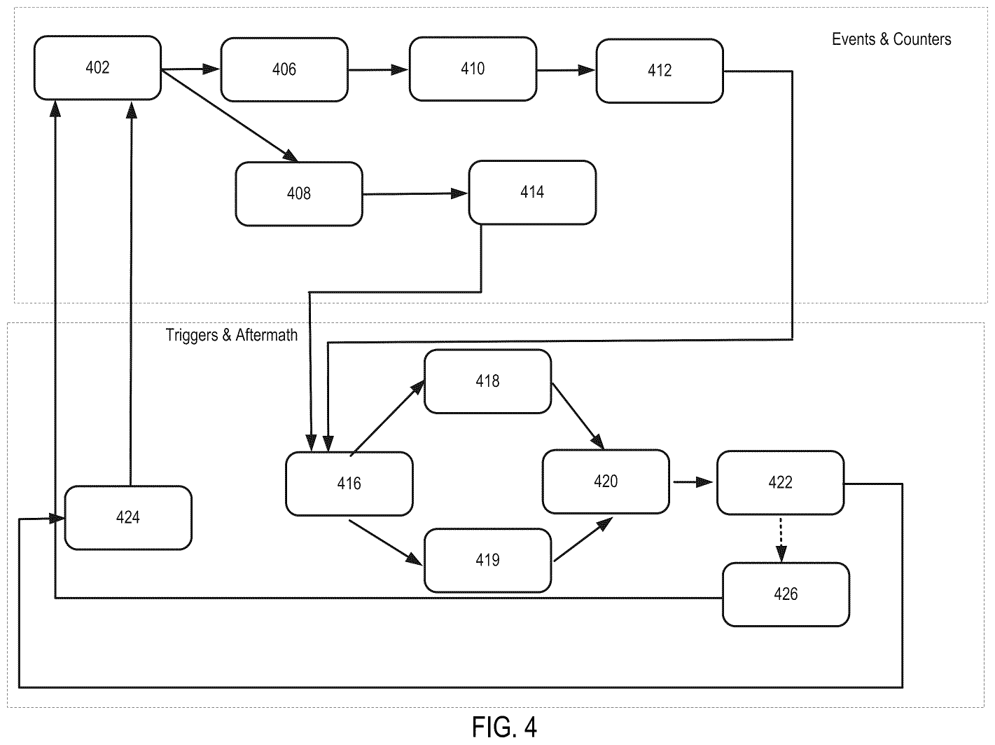

The confusion detector 126 segments samples into fixations and saccades using velocity/dispersion thresholds (e.g., IVT/IDT-style) and identifies regressions to earlier utterances. It maintains per-utterance reread and revisit counters in sliding time windows (e.g., 30-120 s) and resets counters upon user response, large scroll, or UI state change. Triggers require (a) confidence≥C and (b) a false-positive score≤F computed from blink rate, sample dispersion, or rapid head-pose shifts. Upon threshold breach, it signals the assistance prompt generator 128, as illustrated in FIG. 4.

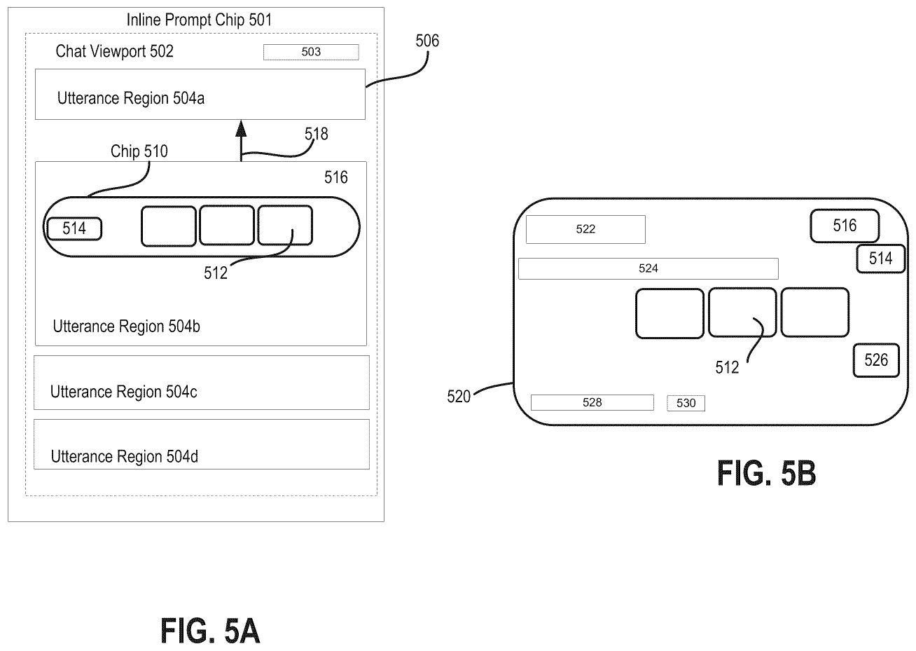

The assistance prompt generator 128 renders non-intrusive, in-thread prompts (e.g., clarify, rephrase, example, step-by-step, more detail) as compact chips or cards anchored to the implicated utterance region. The generator enforces cool-down timers after declines to prevent prompt fatigue and adapts presentation for device context (mobile/desktop). Accepted prompts inform subsequent assistant behavior (e.g., simplified reading level, added examples, accessibility adjustments), as further described with reference to FIG. 5.

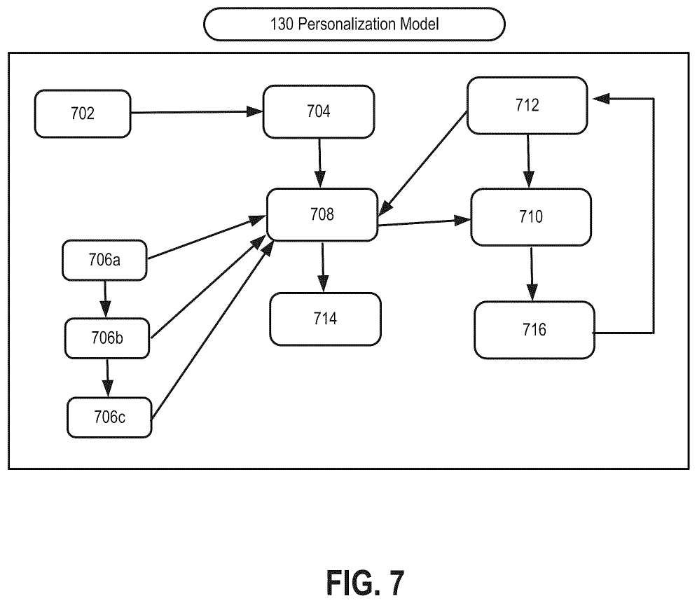

The personalization model 130 adapts thresholds (first/second counts, dwell cutoffs), cool-downs, and prompt styles per user. A population prior initializes parameters; online updates use observed accept/decline events, response latency, and task completion (e.g., Bayesian updates or bandit heuristics). Profiles are stored in the interaction data store 108 with tenant scoping and TTLs, as illustrated in FIG. 7.

The privacy & consent module 132 manages explicit opt-in/opt-out, child-account restrictions, and data-minimization. In preferred embodiments, only derived features (fixation spans, reread/revisit counters, confidence summaries) and prompt outcomes are persisted; raw video and high-frequency gaze samples are not transmitted off-device. The module enforces least-privilege access for external APIs and data sources 170 and governs caching rules in the interaction data store 108.

The analytics logger 134 records derived features, prompt impressions, user selections, and downstream outcomes for A/B evaluation and threshold tuning. Logs are tenant-scoped, encrypted at rest, and subject to retention limits. The logger may emit aggregate metrics (e.g., prompt acceptance rate vs. confidence) without retaining raw gaze.

As described above, connectors to external APIs and data sources 170 may supply definitions/examples, domain guidance, and platform integrations (e.g., Zoom, WhatsApp, enterprise messaging). Cached extracts in 108 are minimal, tenant-scoped, and time-limited; raw gaze/video are never cached.

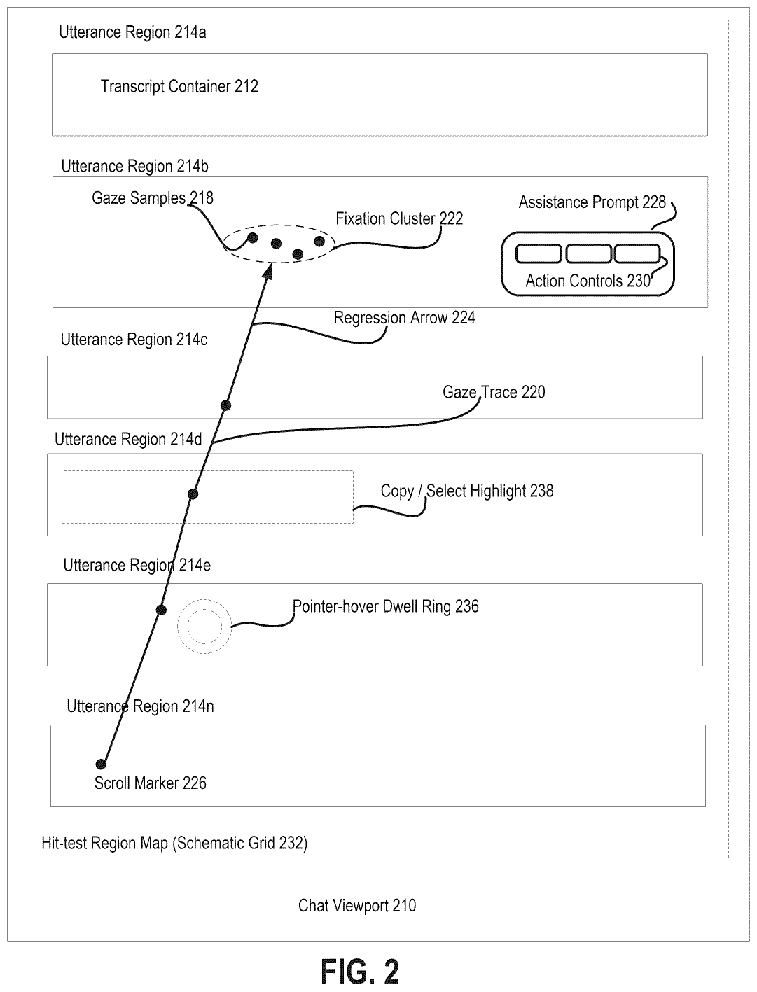

FIG. 2 is a user interface diagram illustrating a chat viewport 210 rendered within the user-facing interface 114, with per-utterance bounding boxes (214a-214n) and a gaze overlay comprising time-stamped gaze samples 218, a gaze trace 220, fixation clusters 222, and a regression arrow 224 pointing to an earlier utterance region. The figure further shows token-span markers 216 within an utterance, a scroll position indicator 226, and an assistance prompt chip 228 with action controls 230 anchored to the implicated utterance region. For embodiments without camera access, the figure depicts look-back proxies including a pointer-hover dwell ring 236 and a copy/select highlight 238 over an utterance region. A hit-test region map 232 schematically represents how the gaze-UI mapper 124 associates gaze samples to utterance regions for consumption by the confusion detector 126.

In a present embodiment, the user-facing interface 114 presents a chat viewport 210 containing a transcript container 212 in which assistant and user utterances are rendered as respective utterance regions 214a-214n. Each region includes layout metadata (position, size) and, in some cases, token-span markers 216 enabling sub-utterance alignment. The gaze-UI mapper 124 receives gaze samples 218 and draws a gaze trace 220 for illustration. Samples that satisfy fixation thresholds are grouped into fixation clusters 222, and a regression arrow 224 denotes a saccade from a later to an earlier utterance region. A scrollbar or scroll marker 226 denotes a boundary used by the confusion detector 126 to reset per-utterance counters when the viewport moves beyond a threshold.

When a reread or revisit threshold is exceeded with sufficient confidence score (see definitions), an assistance prompt chip 228 appears inline, anchored to the implicated utterance region (e.g., 214c), and provides action controls 230 (e.g., clarify, rephrase, example, step-by-step, more detail). In embodiments where camera permissions are denied or confidence is below a threshold, look-back proxies visualize attention: a pointer-hover dwell ring 236 grows with dwell duration within an utterance region, and a copy/select highlight 238 indicates text selection events that may contribute to reread counts. A schematic hit-test region map 232 (shown as a light overlay grid) represents the spatial mapping used to associate gaze and proxy events to utterance regions.

FIG. 3 illustrates a gaze-processing pipeline spanning a client device 110 and a server 102. Sensors 116/118 (camera and/or dedicated tracker) produce raw frames 302 that are processed by an on-device gaze estimator (module 122) to yield time-stamped gaze samples with confidence 308. The samples are mapped to utterance regions by hit-testing 312 (module 124), then analyzed by a confusion detector (module 126) comprising 314 fixation segmentation, 316 regression detection, 328 sliding-window maintenance, and 318 reread/revisit counters. A confidence gate 324 and false-positive filter 326 gate a trigger decision 320, which emits an assistance-prompt signal 322 to the UI. Derived features are written to a log 336; raw frames are discarded at 334.

In some embodiments, camera 116 produces RGB (or IR) frames at approximately 30-120 Hz with per-frame timestamps tᵢ. A dedicated eye-tracking device 118 may output frames, eye landmarks, and/or gaze vectors. Frames 302 include calibration metadata (resolution, DPI, focal length if known) and are tagged with device pose when available.

An eye-landmark stage 304 detects eyelid and pupil landmarks (e.g., 6-32 points per eye) and optionally estimates head-pose (yaw, pitch, roll). A gaze-vector stage 306 converts landmarks to a 2D (screen-space) or 3D (view-vector) estimate using either (i) a geometric model (pupil-corneal reflection and pinhole camera) or (ii) a neural regressor. Head-pose compensation may be applied to reduce parallax. The estimator outputs (xᵢ, yᵢ, tᵢ, cᵢ), where (xᵢ, yᵢ) are screen coordinates, tᵢ is a monotonic timestamp, and cᵢ E [0, 1] is a confidence score reflecting detector probability, landmark quality, and head-pose feasibility.

Samples are optionally smoothed using an exponential moving average or Savitzky-Golay filter with a window of 3-7 points. When a tracker 118 emits gaze directly, its output may bypass 304/306 and be normalized into 308. Dropped or jittery points are interpolated if the gap<T_gap (e.g., 50 ms). Sample-level confidence cᵢ is propagated to event-level confidence later.

In preferred embodiments, raw frames 302 are processed on the client and then discarded at 334. Only derived samples 308 and downstream features (fixation spans, counters) traverse the network. If a user opts into diagnostics, frames may be retained briefly (e.g., TTL≤24 h) with encryption and tenant scoping.

The server (or client, in some variants) executes 312 to map each sample (xᵢ, yᵢ, tᵢ) to an utterance region by intersecting with layout bounding boxes (xL, yT, xR, yB) provided by the chat interface. For long utterances, token-span subregions may be used. The mapper accounts for scroll offset and zoom; when the UI is virtualized, off-screen regions are ignored. Output is a stream (rᵢ, tᵢ, cᵢ), where rᵢ identifies the utterance (and optionally token span) under gaze at time tᵢ.

The stream is segmented into fixations and saccades using one or both of: I-VT (velocity threshold): convert pixel velocity to visual-angle velocity vᵢ (deg/s) via pixels-to-degrees factor κ (computed from DPI and estimated eye-screen distance). A fixation begins when vᵢ<vₜₕᵣ for at least T_{fix,min} (e.g., vₜₕᵣᵥ≈30-60°/s; T_{fix,min}≈60-200 ms); and I-DT (dispersion threshold): within a sliding window of width W (e.g., 100-200 ms), dispersion D=(max(x)−min(x))+(max(y)−min(y))<Dₜₕᵣ (e.g., 0.5-1.5°) denotes a fixation. Short gaps (≤T_merge, e.g., 50-75 ms) between adjacent fixations on the same region may be merged; micro-saccades shorter than T_micro (e.g., <30 ms) may be ignored.

Let U be the ordered list of visible utterances from oldest (top) to newest (bottom). A regression event occurs when a saccade transitions from a fixation on region uj to a fixation on region ui where i<j (earlier in U). The event payload includes source/target regions, saccade amplitude, and latency. Regressions landing on question-type regions are flagged for revisit counting.

For each utterance region u, the system maintains a sliding time window Wu (e.g., 30-120 s) anchored to the current viewport. Windows reset upon any of: (i) the user posts a response to u; (ii) the viewport scrolls beyond a threshold offset relative to u; or (iii) a material UI state change (e.g., thread collapse). Windowing prevents stale events from accumulating across long sessions.

Within Wᵤ, the system maintains: reread_count [u]: increment when a fixation on u has dwell≥Dₘᵢₙ (e.g., 120-300 ms) or when multiple fixations on u occur separated by ≤T_merge; revisit_count[u]: increment when a regression lands on u and no intervening user response to u has been detected. Event-level confidence Cₑᵥₑₙₜ is computed (e.g., median ci over the fixation span, or min across constituent samples) and attached to each increment. Cool-down timers can suppress repeated triggers for the same u within T_{c} (e.g., 10-30 s).

The confidence gate C checks that events used for triggering meet or exceed a minimum confidence Cₘᵢₙ (e.g., 0.6-0.8). Cₑᵥₑₙₜ may combine tracker confidence, landmark quality, and mapping certainty (e.g., overlap of fixation centroid with the region, proximity to edges). Only counters backed by events satisfying Cₑᵥₑₙₜ≥Cₘᵢₙ are considered.

A false-positive score F is estimated from features such as blink bursts, excessive sample dispersion, abrupt head-pose change, and zig-zag jitter indicative of UI lag. The filter may also down-weight events near screen borders or during high scroll velocity.

The trigger decision 320 fires for region u when: (revisit_count[u]≥T₁)∨(reread_count[u]≥T₂) and both gates pass (C≥Cₘᵢₙ∧F≤Fₘₐₓ) and any cool-down for u has expired. Thresholds T₁, T₂ may be global, per-tenant, or personalized. Upon firing, the system emits assistance-prompt signal 322 describing the implicated region u, reason code (reread/revisit), and recommended actions (e.g., clarify, rephrase, example, step-by-step, more detail). The chat interface module 120 renders the assistance prompt 228 anchored to u with action controls 230.

The system writes compact, non-identifying records to 336, e.g., (u, tₛₜₐᵣₜ, t_{end}, dwell, Cₑᵥₑₙₜ, reason, triggered?). Logs exclude raw frames and high-rate gaze sequences. Data are tenant-scoped, encrypted at rest, and retained per policy (e.g., 30-90 days) to support A/B evaluation and threshold tuning. The privacy & consent module 132 governs retention and access.

Without limitation, workable parameter ranges include: frame rate 30-120 Hz; vₜₕᵣ=30-60 deg/s; T_{fix,min}=30-60 deg/s; T_{fix,min}=60-200 ms; Dₜₕᵣ=0.5-1.5 deg; T_{merge}=50-75 ms; Wᵤ=30-120; Wᵤ=30-120 s; T₁=2-3 revisits; T₂=3-5 rereads; Cₘᵢₙ=0.6-0.8; Fₘₐₓ=0.3-0.5. These values are illustrative; in a present embodiment they are configurable and/or learned.

In some embodiments, a tracker 118 outputs fixations directly; 304/306 are reduced or bypassed. In others, 312 executes on-device to avoid network latency. When camera access is unavailable, look-back proxies (pointer hover dwell, scroll regressions, selection/copy) are converted into synthetic fixation/regression events that enter the pipeline at 318 (not shown). The described modules may be implemented in different orders or merged; for example, 314 and 316 may be fused in a single temporal model.

Although not depicted in FIG. 3, a personalization model 130 may adjust T₁, T₂, dwell cutoffs, and cool-downs based on prior accept/decline rates, response latency, and task completion, with parameters stored in the interaction data store 108. Personalized parameters feed into 318, 324, and 320 to reduce false positives and tailor assistance.

FIG. 4 depicts a state machine executed per utterance region u to determine when to emit an assistance prompt. Events originate from the gaze-processing pipeline (see FIG. 3), namely fixation segmentation 314, regression detection 316, sliding-window maintenance 328, and counter updates 318. The state machine comprises: 402 observe; 406 valid fixation on u; 408 regression to u; 410 window start/maintain/reset; 412 increment of reread_count[u]; 414 increment of revisit_count[u]; 416 threshold check; 418 confidence gate C; 419 false-positive filter F; 420 trigger decision; 422 assistance-prompt signal; 424 cool-down; and 426 reset conditions.

In state 402, the system listens for region-aligned events for u. Events whose sample-level confidence is below a preliminary low watermark (e.g., cᵢ<0.3) are ignored. Entry into 402 occurs (i) at session start, (ii) after cool-down expiry (424), or (iii) upon any reset (426). The machine maintains prior counters and timestamps for u in memory unless reset applies.

State 406 is entered when 314 reports a fixation whose centroid lies within u and whose dwell exceeds a minimum Dₘᵢₙ (e.g., 120-300 ms) after micro-saccade merging. The event carries an event-level confidence Cₑᵥₑₙₜ (e.g., median of the underlying sample confidences) and a dwell estimate.

State 408 is entered when 316 detects a saccade landing on u from a later utterance region (earlier in the visual stack). Regression payload includes source/target regions, amplitude, and latency. If a user response to u has occurred since the last fixation on u, the regression is marked “non-revisit” and will not increment the revisit counter.

In 410, the system creates or updates the sliding window Wᵤ (e.g., 30-120 s) for u. The window resets upon any of: (i) posting a user response to u; (ii) scrolling beyond a viewport boundary relative to u; or (iii) a material UI state change (thread collapse/expand, route change). If reset occurs, control returns to 402.

Reread increment (412). If the preceding event path was 406 to 410, the system increments reread_count[u] when dwell≥Dₘᵢₙ or multiple fixations on u occur separated by ≤T_{merge}. The increment records (tₛₜₐᵣₜ, t_{end}, Cₑᵥₑₙₜ) and advances to 416.

Revisit increment (414). If the preceding path was 408 to 410, the system increments revisit_count[u] provided that no intervening user response to u is recorded within Wᵤ. The increment also carries Cₑᵥₑₙₜ and advances to 416.

The system compares counters to thresholds T₁ (revisit) and T₂ (reread). Thresholds may be global, tenant-specific, or personalized per user by model 130 (e.g., bandit/Bayesian updates). If neither threshold is met, control returns to 402 while Wᵤ and counters persist.

When a threshold is met, the confidence gate C accepts only if Cₑᵥₑₙₜ≥Cₘᵢₙ (e.g., 0.6-0.8). Cₑᵥₑₙₜ may combine tracker confidence, fixation quality, and mapping certainty (overlap between fixation centroid and u). Failure at 418 drops the event and returns to 402.

In parallel with 418, a false-positive score F is computed (e.g., from blink bursts, dispersion, abrupt head-pose change, high scroll velocity, or edge proximity). The event proceeds only if F≤Fₘₐₓ (e.g., 0.3-0.5); otherwise, the machine returns to 402. In some embodiments, 418 and 419 run in either order or jointly as a composite predicate.

If 416 passes and both gates succeed, 420 fires for u with a reason code (REREAD or REVISIT), supporting metadata (dwell, counts), and a proposed action set based on prompt policies (see 128). In certain embodiments, 420 also checks a per-utterance cool-down flag to avoid repeated prompts.

State 422 emits a UI command specifying u, anchor coordinates within the utterance region, reason code, and action controls (e.g., clarify, rephrase, example, step-by-step, more detail). The chat interface module 120 renders the inline prompt 228 with action controls 230. Prompt impressions and user selections are logged as derived features in 336.

After signaling 422, the machine enters 424 for a cool-down interval T_{c} (e.g., 10-30 s) during which additional triggers for u are suppressed. If the user explicitly rejects the prompt, T_{c} may be extended; if the user accepts and completes a follow-up, T_{c} may be shortened. Upon cool-down expiry, the machine returns to 402.

State 426 represents global interrupts that abandon Wᵤ and counters for u and return to 402. Examples include: (i) a user response posted to u; (ii) scroll beyond a boundary relative to u; (iii) a material UI state change; (iv) device/session transfer; or (v) sustained tracker confidence drop below Cₘᵢₙ for T_{drop}. As illustrated in FIG. 4, 426 flows to 402, however, in some embodiments, dashed inbound arrows from representative nodes (e.g., 410, 422) indicate that 426 may be entered from multiple states.

The state machine runs concurrently for multiple utterances. If two utterances satisfy 420 within a short interval, the system may prioritize the more recent utterance or the one with higher Cₑᵥₑₙₜ, or queue prompts with a per-thread rate limit (e.g., ≤1 prompt every T_{q} seconds).

When camera access is unavailable, look-back proxies (pointer hover dwell, scroll regressions, selection/copy) are converted into synthetic fixation/regression events that enter at 406/408 and proceed through the same 410 to 422 path. In some embodiments, 418 and 419 incorporate proxy-specific quality features (e.g., pointer jitter, dwell stability).

The machine persists only derived features (e.g., counter increments, Cₑᵥₑₙₜ, reason code, trigger outcomes) in the interaction data store 108 with tenant scoping and retention limits. Raw frames 302 are not stored (see 334).

FIG. 5A illustrates an inline assistance prompt 510 rendered within chat viewport 502 (transcript container 503) adjacent to one of the utterance regions 504a-504d. The implicated utterance is denoted 506. FIG. 5B illustrates an expanded prompt card 520, which is a popover anchored to the same implicated utterance 506. Both variants are invoked by the assistance-prompt signal 322 emitted by the trigger decision 320 (see FIG. 4).

The chip 510 is a compact, pill-shaped container positioned above or below 506 and visually connected to 506 via a short caret 518 that touches the border of the implicated region. The chip contains action controls 512 (two to four rounded buttons), an optional reason badge 514 (“REREAD” or “REVISIT”), and a dismiss control 516 (a small close affordance). The chip is sized to avoid reflow of the surrounding transcript; typical height is 24-40 px with 8-16 px of horizontal padding. The chip remains localized to the implicated message and scrolls with 503.

The expanded prompt card 520 is a larger popover with rounded corners, anchored to 506 via caret 518. The card includes: a header strip 522 summarizing the assistance intent; an explanation/preview region 524 (e.g., rephrase, definition, or example snippet); action controls 512; dismiss control 516; cool-down indicator 526 (badge or timer); an optional “don't show for this message” control 528; and an accessibility live-region marker 530 to ensure screen-reader announcement. A settings/reading-level toggle 532 may be included in certain embodiments to bias future responses (e.g., simpler wording). The card's width is constrained to the message column; on narrow screens the same layout may be presented as a compact modal while retaining numerals 520, 522, 524, 512, 516, 526, 528, 530, 532.

The chat interface 120 (together with the assistance prompt generator 128) selects 510 versus 520 according to (i) available viewport space and occlusions, (ii) reason code (reread vs. revisit), (iii) personalization model 130 preferences, and (iv) tenant policy. For example, if 524 requires >N characters or contains structured content (list, code, or math), the system selects 520; otherwise, 510 is preferred.

For either variant, the system computes the bounding box of 506 from the hit-test map (see 312) and chooses a placement offset (above or below 506) that minimizes occlusion within 502. If the chosen position would collide with the next utterance, the chip/card is flipped to the opposite side. The caret 518 is positioned at the horizontal centroid of 506 unless that would intersect a link or control; in that case 518 is shifted to the nearest safe location. During scroll, the prompt maintains a fixed offset to 506; if 506 leaves the viewport by more than a threshold, the prompt auto-dismisses and a cool-down is started (526), or the prompt transitions to a compact banner depending on policy.

Selecting an action control 512 (e.g., Rephrase, Give example, Step-by-step) dispatches a command to 128, which generates a follow-up utterance aligned to 506 (optionally inserting a preview into 524 before send). Activating 516 dismisses the prompt and starts/extends the cool-down 526 for the implicated region. Checking 528 suppresses further prompts for 506 within the current thread (or until reset 426). All outcomes are logged as derived features in 336 with region id, reason code, and timestamps.

The cool-down indicator 526 reflects an active suppress window T_{c} (e.g., 10-30 s). The system also enforces a per-thread prompt budget (e.g., ≤1 prompt per T_{q}) and a per-session cap. Cool-downs reset on explicit user response to 506 or upon global reset 426.

The expanded card sets 530 as a live region (e.g., ARIA polite) and moves keyboard focus to the first actionable 512; Escape activates 516. All controls are reachable by keyboard and have descriptive names. High-contrast mode increases stroke widths and font size; reduced-motion mode disables entrance animations. Text in 522 and 524 respects locale and reading-level settings (optionally toggled via 532).

Model 130 may reorder 512 by predicted utility, decide whether to surface 524 by default, and tune T_{c} for 526 based on prior accept/decline rates and task success. User or tenant-level policies can pin the default variant (510 vs. 520) and disable 528 if desired.

The prompt UI conveys assistance without revealing raw gaze data. Only derived features (fixation spans, counters, reason code, prompt outcome) are stored in 108 per policy managed by 132; raw frames are discarded at 334. If the preview 524 requires external content (e.g., domain examples), retrieval occurs via connectors 170 under tenant scoping and consent (132).

If anchoring would occlude critical UI or overflow 502, the prompt snaps to a safe fallback (e.g., bottom-pinned banner) while retaining the same numerals. If confidence at 418 falls below Cₘᵢₙ after the prompt appears, the system may dim 524 and postpone actions until confidence recovers or the user explicitly proceeds.

Without limitation: chip height 28 px, card corner radius 8-12 px, caret length 8-12 px, minimum chip-to-utterance gap 6-10 px, maximum card width 70-90% of transcript column, cool-down T_{c}=15 s, per-thread budget T_{q}=45 s. Values are configurable and may be learned.

On small devices the card 520 may present as a sheet/modal while preserving numerals; 518 indicates logical anchoring rather than a literal tail. When the conversation resumes on a different device, an in-place chip 510 may be re-issued for the last implicated 506 if the prior prompt was dismissed during an active cool-down.

Prompt emissions, selections of 512, use of 528, and changes to 532 are audit-logged (tenant-scoped) with hashed user ids. Logs respect TTL and erasure policies configured through 132.

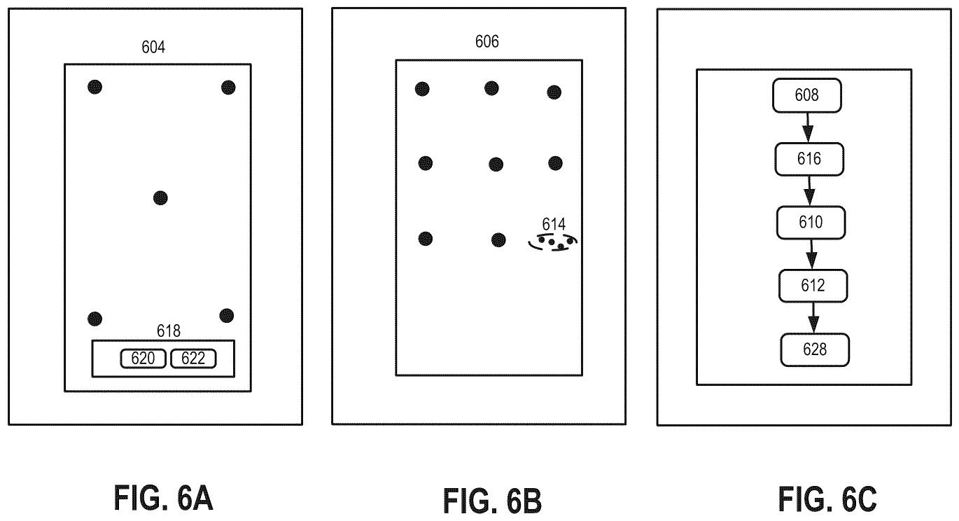

FIGS. 6A-6C depict procedures executed by the gaze-UI mapper 124 to align tracker output with rendered utterance regions. A quick calibration (FIG. 6A) establishes a provisional mapping; a full calibration (FIG. 6B) refines the fit and exposes residual error; and a correction stack (FIG. 6C) applies run-time transforms and validation before gaze events are supplied to segmentation 312 and gates 418/419.

A five-target sequence 604 (four corners and center) is rendered within the chat viewport. For each target, the system records fixations that satisfy dwell/dispersion criteria and aggregates a calibration quality indicator 618 computed from (i) per-target fixation dispersion, (ii) coverage of all points, and (iii) tracker confidence statistics. The user may accept 620 or skip 622 the result. Upon acceptance, a provisional planar mapping is produced; upon skip, prior device parameters are reused and confidence at the gate 418 is clamped below Cₘᵢₙ until a later calibration completes.

When 620 is selected, the mapper estimates a homography using the observed fixations and the known screen coordinates of 604, and stores the parameters ephemerally for the current device/profile. If the quality 618 falls below a threshold (e.g., excessive corner error or incomplete coverage), the system automatically proceeds to the full calibration (FIG. 6B) or continues with reduced confidence weighting at 418.

A nine-target grid 606 is presented (3×3). Robust fitting uses target-wise medians and outlier rejection to refine the mapping. Residual error is visualized as an error ellipse 614 summarizing dispersion around a representative point; the system computes peak and mean residuals and updates the confidence model used by 418. If residuals exceed policy limits, the mapper flags calibration as degraded, requests re-targeting, and suppresses high-precision behaviors (e.g., small-region hit-tests) until success.

At runtime the mapper applies a correction stack comprising head-pose compensation 608 (e.g., yaw/pitch estimated from the camera), distance scaling 616 (viewer distance inferred from interpupillary geometry or device heuristics), screen/DPI profile 610 (zoom/scale and physical pixel density), and the planar homography 612 from calibration. A post-fit validation 628 computes overlap between mapped gaze samples and active hit regions; failure of 628 reduces event confidence, triggers a brief in-line re-target prompt, or reverts to the quick calibration of FIG. 6A.

Calibration parameters are cached per device and display profile in the interaction data store 108 with decay over time. The mapper opportunistically refines 612/608/616 using natural reading fixations (micro-updates) without interrupting the session. Material UI changes (window zoom, rotation, external display switch) invalidate 610 and prompt a short re-run of 604.

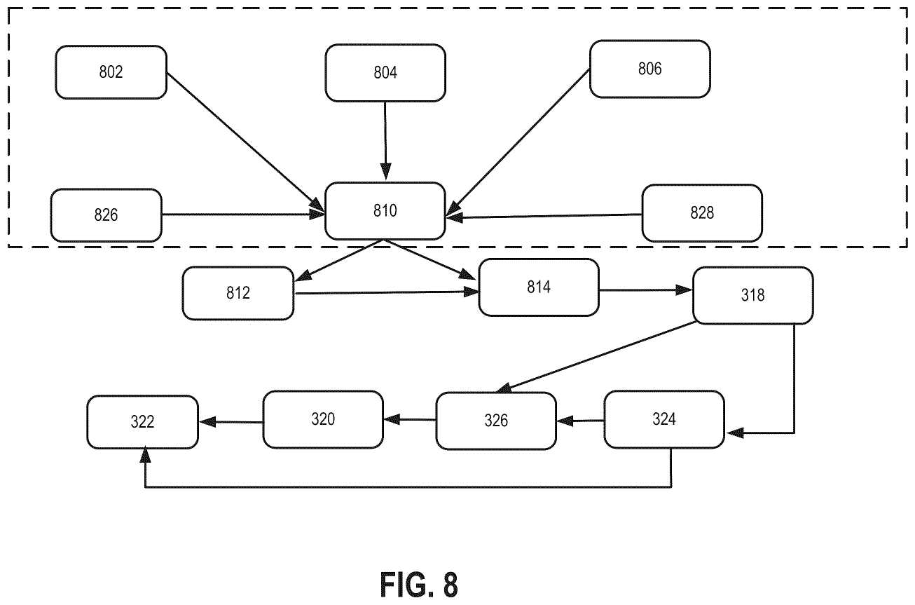

Only when a valid calibration is present and 628 passes does the mapper emit utterance-aligned events to the state machine of FIG. 4; otherwise, event confidence at 418 is reduced or the system falls back to proxy signals, as illustrated below in reference to FIG. 8.

FIG. 7 depicts a personalization subsystem 130 configured to adapt prompting behavior and detection thresholds per user and tenant. The subsystem consumes priors 702, user/tenant profiles 704, and feedback signals 706a-706c, learns updated parameter settings via a learner 708, enforces policy constraints 714, produces parameter outputs 710, optionally evaluates alternative settings with an A/B evaluator 712, and deploys selected settings to a parameter sink 716 that applies them at runtime to the confusion detector 126, trigger decision 320, chat interface 120, and assistance prompt generator 128.

Population priors 702 encode default parameter distributions (e.g., Beta/Gaussian posteriors for thresholds and cool-downs) derived from historical, anonymized cohorts. Profile store 704 persists user-and tenant-scoped statistics (e.g., reading speed estimates, prior prompt accept/decline counts, last-used UI variant, device form factor history). Profiles are stored in the interaction data store 108 with tenant isolation and TTL as governed by 132.

The subsystem ingests multiple, heterogeneous signals including: 706a prompt outcomes (impression, accept, dismiss, “don't show” 528), 706b post-prompt behaviors (latency to first meaningful reply, message edit rate, need for follow-up clarifications), and 706c nuisance indicators (false-positive annotations from 326, rapid dismissals, cool-down overruns, and viewport occlusion events). Signals are time-stamped and keyed to the implicated utterance 506 and reason code (REREAD/REVISIT).

The learner combines 702, 704, and 706a-706c to update parameter posteriors for: revisit/reread thresholds T₁, T₂, minimum dwell Dₘᵢₙ, cool-down Tc, gate levels Cₘᵢₙ and Fₘₐₓ (used by 418/419), prompt-rate limit T_{q}, and UI policy weights (preference for chip 510 vs. card 520, action ordering for 512, verbosity for 524). In one embodiment 708 implements a contextual multi-armed bandit with Thompson sampling; context features include device type, viewport size, user reading-speed quantile, and historical acceptance rate. In another embodiment, 708 is a Bayesian updater that maintains conjugate priors per parameter and applies exponential time decay so recent sessions influence more strongly.

Outputs from 708 are filtered by 714 to enforce hard organizational and safety limits, such as: minimum confidence Cₘᵢₙ≥0.6, maximum false-positive tolerance Fₘₐₓ≤0.4, per-thread prompt budget (e.g., ≤1 per T_{q}), child-account restrictions (disable personalization or cap T_{c}), and locale-specific accessibility policies (e.g., increased contrast and font size). The gate 714 may also pin parameters to tenant-wide values during audits or rollbacks.

Outputs 710 and Evaluation 712. The filtered parameter set 710 is an atomic bundle (with version id and validity window) suitable for deployment. Optionally, the evaluator 712 instantiates one or more alternative bundles (e.g., different T_{c} or chip/card policy) and assigns them to traffic splits for online comparison; evaluation metrics include utility (accept rate, reduced follow-up questions) and burden (dismiss rate, user-initiated snoozes). Results flow back from 712 to 708 to update posteriors and may also adjust per-feature exploration rates.

The parameter sink 716 writes the selected bundle to a fast cache and signals dependent modules: 126 reads T₁, T₂, Dₘᵢₙ and gate settings Cₘᵢₙ and Fₘₐₓ; 320 consumes the per-thread budget and cool-down T_{c}; 120/128 read UI policy (chip vs. card, 512 ordering, default inclusion of 524). Deployment is transactional and versioned; if any module reports incompatibility, 716 reverts to the last known-good bundle.

Updates are throttled (e.g., at most once per session or per N prompts). For cold starts with little or no history, 130 serves the population prior 702 or tenant-level defaults and gradually personalizes after a minimum evidence threshold (e.g., ≥5 prompt outcomes).

The subsystem enforces fairness constraints by bounding parameter drift and auditing disparate impact across cohorts (e.g., device classes, locales). If an audit rule fails, 714 clamps parameters to safe ranges and schedules a re-evaluation via 712.

Personalization uses only derived features; no raw frames are stored (frames are discarded at 334). Profiles in 704 are tenant-scoped, encrypted, and subject to data-subject requests via 132. Users may opt out of 130; in that mode the system freezes parameters at policy defaults and disables learning.

If 708 diverges (e.g., abnormal spike in dismissals), the evaluator 712 triggers an automatic rollback to a pinned bundle from 710 and raises an audit event. During network loss, 716 continues using the last local bundle until expiry.

Without limitation: T₁ E [2,4] revisits, T₂ E [2, 5] rereads, Dₘᵢₙ E [120, 300] ms, Tc E [10, 30] s, Cₘᵢₙ E [0.6, 0.8], Fₘₐₓ E [0.3, 0.5]. UI policy may set a prior probability p(card 520)p(\text{card}520)p(card 520) that increases when 524 exceeds a content length threshold (e.g., >140 characters) or when device width is below a breakpoint.

By closing the loop across 702, 704, 706a-706c, 708, 714, 710/712, and 716, the personalization model 130 reduces prompt fatigue, improves assistance acceptance and task completion, and preserves tenant controls-while remaining compatible with the gaze and proxy pipelines of FIGS. 3-4 and the UI variants of FIGS. 5A-5B.

FIG. 8 illustrates operation of the system when camera-based gaze is unavailable or unreliable. Pointer-hover dwell 802, scroll regression 804, and copy/select events 806 are collected within the chat interface 120. States 826 (camera unavailable) and 828 (permission denied) indicate conditions in which proxy mode is active. These inputs are received by an aggregator 810 that fuses the events into attention signals.

Aggregator 810 operates over a sliding window (e.g., 2-5 s) and produces synthetic fixation 812 and synthetic regression 814 events. Each synthetic event includes a proxy-derived confidence score computed from features such as pointer dwell duration and stability (for 802), scroll velocity and direction change (for 804), and repeat select/copy sequences and focus persistence (for 806). When states 826 or 828 are present, 810 assigns full proxy weighting; in other situations (e.g., intermittently low tracker confidence) 810 may down-weight proxies according to policy or personalization 130.

Synthetic events 812 and 814 update the per-utterance counters 318 (e.g., reread_count, revisit_count) used by the confusion detector 126. Counter updates flow through a confidence gate 324, which requires that aggregate confidence for the implicated utterance exceed a minimum level Cₘᵢₙ, and a false-positive filter 326 that rejects events associated with rapid overscroll, accidental text selection, or pointer flicks.

When the gate 324 and filter 326 are satisfied and the counters 318 cross configured thresholds (e.g., T₁ for revisit, T₂ for reread), the trigger decision 320 asserts the assistance-prompt signal 322. Budget and cool-down policies (see FIG. 5) are enforced at 320; upon prompt emission 322, the implicated utterance's window is reset and a cool-down interval begins.

The downstream assistance behavior is identical to gaze mode: the signal 322 selects either the inline chip 510 or the expanded card 520 per policy, anchors to the implicated utterance 506 via caret 518, and presents actions 512 with optional preview 524. When proxies are in use, the UI may indicate the source of attention signals and provide a single-action path to restore camera permission (828) or device availability (826).

By transforming UI interaction patterns into 812/814 and routing them through 318 to 324/326 to 320 to 322, the embodiment preserves assistance quality even without gaze, while maintaining the same gating, thresholds, and cool-down logic used for camera-based operation.

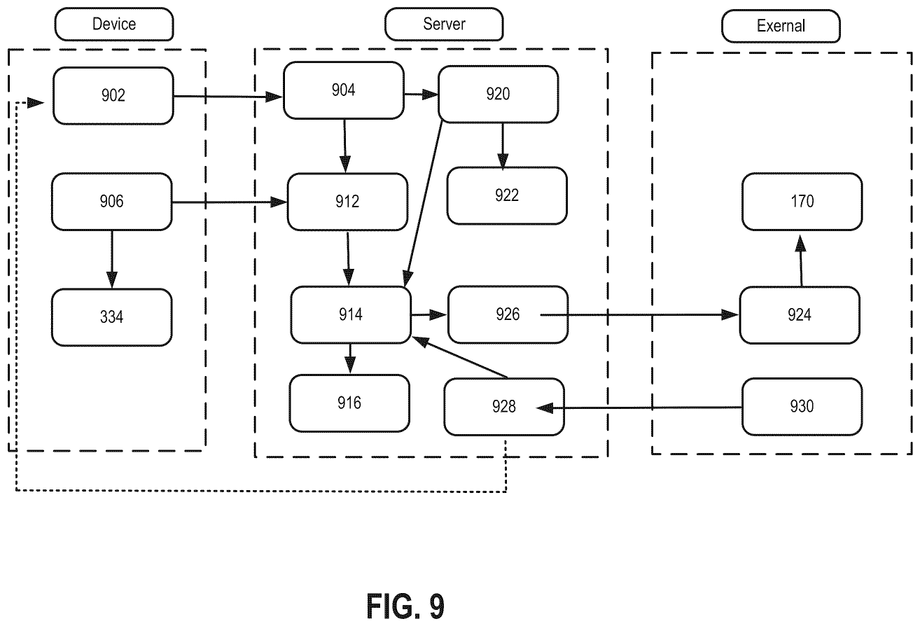

FIG. 9 illustrates data handling and governance across a device domain, a server domain, and external services. The design enforces that only derived features (not raw video) leave the device, and that all third-party access is mediated by server-side policy, minimization, and tenant controls.

A consent UI 902 surfaces user and tenant choices (camera permission, logging of derived features, personalization, and use of external sources). Gaze estimation runs on-device (906) and produces feature streams; raw frames are discarded at 334 (a terminal sink with no outbound connections). When derived features are transmitted, they traverse secure transport in the server domain (see 912) rather than contacting external services directly.

The policy engine 904 applies consent and tenant policy to inbound data and to downstream processing. Data in transit are protected by transport security 912 (e.g., TLS); accepted records are written to the interaction data store 914. A retention TTL 916 imposes time-bounded storage. Tenant isolation 920 scopes data and control paths per tenant and feeds controls to audit logging 922 and to data minimization 926 (and may also constrain access to 914 in some embodiments).

Before any external retrieval or enrichment, entries from 914 are processed by data minimization 926 to remove or aggregate fields (e.g., store counters or anonymized aggregates only). Data-subject requests and privacy actions (export/erase) arrive via 928 and are applied to 914 under tenant policy and audit (922).

Outbound access is performed only through scoped connectors 924, which enforce tenant/user scopes and credentials. When permitted, 924 calls external APIs and data sources 170 to obtain domain glossaries, examples, or enterprise knowledge used in assistance previews (see FIG. 5). A privacy dashboard 930 (e.g., an admin portal) can initiate or relay data-subject requests to 928 and adjust connector scopes; changes take effect server-side and are audited at 922. No user content flows from 924 back to 930; the dashboard reflects status only.

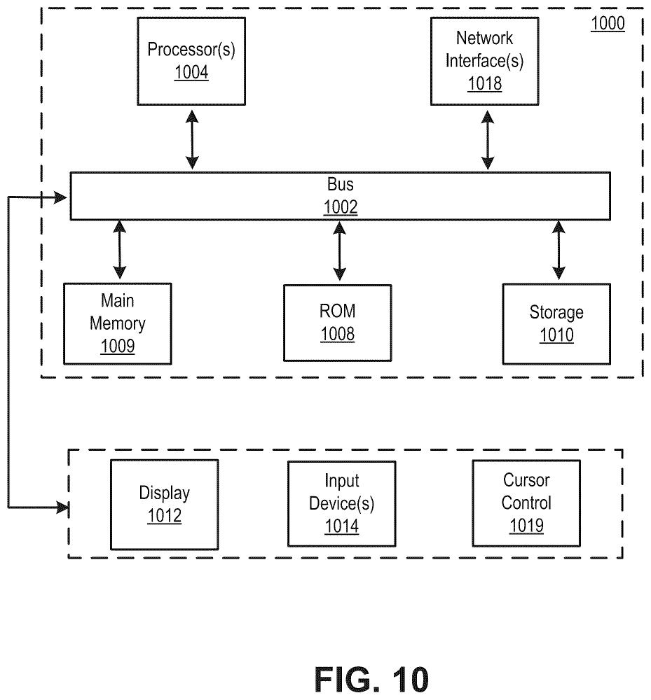

By routing device outputs through 904→912→914, discarding raw frames at 334, constraining storage with 916 and 920, minimizing data via 926 before any connector use 924→170, and honoring data-subject requests through 928, the embodiment provides verifiable privacy guarantees while maintaining functionality for assistance generation and analytics.

Where components, logical circuits, or engines of the technology are implemented in whole or in part using software, in one embodiment, these software elements can be implemented to operate with a computing or logical circuit capable of carrying out the functionality described with respect thereto. One such example computing module is shown in FIG. 10. Various embodiments are described in terms of this example computing module 1000. After reading this description, it will become apparent to a person skilled in the relevant art how to implement the technology using other logical circuits or architectures.

FIG. 10 illustrates an example computing module 1000, an example of which may be a processor/controller resident on a mobile device, or a processor/controller used to operate a payment transaction device, that may be used to implement various features and/or functionality of the systems and methods disclosed in the present disclosure.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 3. Various embodiments are described in terms of this example-computing module 1000. After reading this description, it will become apparent to a person skilled in the relevant art how to implement the application using other computing modules or architectures.

Referring now to FIG. 10, computing module 1000 may represent, for example, computing or processing capabilities found within desktop, laptop, notebook, and tablet computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 1000 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 1000 might include, for example, one or more processors, controllers, control modules, or other processing devices, such as a processor 1004. Processor 1004 might be implemented using a general-purpose or special-purpose processing engine such as, for example, a microprocessor, controller, or other control logic. In the illustrated example, processor 1004 is connected to a bus 1002, although any communication medium can be used to facilitate interaction with other components of computing module 1000 or to communicate externally. The bus 1002 may also be connected to other components such as a display 1012, input devices 1014, or cursor control 1016 to help facilitate interaction and communications between the processor and/or other components of the computing module 1000.

Computing module 1000 might also include one or more memory modules, simply referred to herein as main memory 1006. For example, preferably random-access memory (RAM) or other dynamic memory might be used for storing information and instructions to be executed by processor 1004. Main memory 1006 might also be used for storing temporary variables or other intermediate information during execution of instructions to be executed by processor 1004. Computing module 1000 might likewise include a read only memory (“ROM”) 1008 or other static storage device 1010 coupled to bus 1002 for storing static information and instructions for processor 1004.

Computing module 1000 might also include one or more various forms of information storage devices 1010, which might include, for example, a media drive and a storage unit interface. The media drive might include a drive or other mechanism to support fixed or removable storage media. For example, a hard disk drive, a floppy disk drive, a magnetic tape drive, an optical disk drive, a CD or DVD drive (R or RW), or other removable or fixed media drive might be provided. Accordingly, storage media might include, for example, a hard disk, a floppy disk, magnetic tape, cartridge, optical disk, a CD or DVD, or other fixed or removable medium that is read by, written to or accessed by media drive. As these examples illustrate, the storage media can include a computer usable storage medium having stored therein computer software or data.

In alternative embodiments, information storage devices 1010 might include other similar instrumentalities for allowing computer programs or other instructions or data to be loaded into computing module 1000. Such instrumentalities might include, for example, a fixed or removable storage unit and a storage unit interface. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 1000.

Computing module 1000 might also include a communications interface or network interface(s) 1018. Communications or network interface(s) interface 1018 might be used to allow software and data to be transferred between computing module 1000 and external devices. Examples of communications interface or network interface(s) 1018 might include a modem or softmodem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications or network interface(s) 1018 might typically be carried on signals, which can be electronic, electromagnetic (which includes optical) or other signals capable of being exchanged by a given communications interface. These signals might be provided to communications interface 1018 via a channel. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 1006, ROM 1008, and storage unit interface 1010. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 1000 to perform features or functions of the present application as discussed herein.

Various embodiments have been described with reference to specific exemplary features thereof. It will, however, be evident that various modifications and changes may be made thereto without departing from the broader spirit and scope of the various embodiments as set forth in the appended claims. The specification and figures are, accordingly, to be regarded in an illustrative rather than a restrictive sense.

Although described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the present application, whether or not such embodiments are described and whether or not such features are presented as being a part of a described embodiment. Thus, the breadth and scope of the present application should not be limited by any of the above-described exemplary embodiments.

Terms and phrases used in the present application, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A computer-implemented method for gaze-adaptive assistance in a conversational user interface, comprising:
rendering, on a client device display, a chat interface that presents a sequence of utterances;
receiving, from an eye-tracking engine, a time series of gaze samples during a session;
mapping, using a calibration-derived screen-space mapping and hit-testing, the gaze samples to utterance regions of the chat interface;
maintaining, within a sliding time window, (i) a revisit count to a displayed question without a user response and (ii) a reread count of a displayed statement based on the mapped samples;
segmenting the time series into fixations and saccades and computing dwell time and regression events over the utterance region;
filtering events that fail a confidence threshold and a false-positive filter;
responsive to the counts satisfying the thresholds and gates, generating an assistance prompt targeted to the corresponding utterance, the prompt offering at least one of: a clarification, a rephrased version, an example, step-by-step guidance, or additional detail;
presenting the assistance prompt as an inline chip or expanded card anchored to the utterance;
receiving user input to the assistance prompt; and adapting subsequent assistant output according to the user input.

2. The method of claim 1, wherein the first and second thresholds are personalized per user by a model initialized from a population prior and updated based on prompt accept/decline outcomes.

3. The method of claim 1, wherein mapping comprises associating gaze samples to token spans within an utterance to distinguish rereads of different portions of the utterance.

4. The method of claim 1, further comprising applying a cool-down interval after a declined prompt to reduce prompt fatigue.

5. The method of claim 1, wherein the assistance prompt is emitted only when a tracker confidence is at least C and a false-positive score computed from blink rate, head pose, or sample dispersion is at most F.

6. The method of claim 1, further comprising executing a calibration routine that adjusts screen-space mapping based on pupil distance and head pose.

7. The method of claim 1, wherein adapting subsequent assistant output comprises automatically switching to a simplified reading level and increasing font size or contrast when a reread count exceeds a threshold.

8. The method of claim 1, further comprising, when gaze signals are unavailable or below confidence, detecting rereads and revisits using look-back proxies including pointer hover dwell over an utterance region and scroll regressions into the utterance region, and triggering the assistance prompt based on proxy thresholds.

9. The method of claim 1, further comprising performing gaze estimation on-device and transmitting only derived features comprising fixation spans, reread counts, and revisit counts, while discarding raw video frames post-inference.

10. The method of claim 1, further comprising persisting gaze-labeled context so that, upon transferring the session to a second device, the assistance prompt is re-issued in a format adapted to the second device.

11. A computer-implemented system for gaze-adaptive assistance in a conversational user interface, comprising:
one or more processors; and
a non-transitory computer-readable medium storing instructions that, when executed by the one or more processors, cause the system to implement:
a chat interface module configured to render, on a client device display, a chat interface that presents a sequence of utterances;
a gaze acquisition engine interface configured to receive, during a session, a time series of gaze samples;
a gaze-UI mapper configured to map the gaze samples to utterance regions of the chat interface using a calibration-derived screen-space mapping and hit-testing;
a fixation segmenter configured to segment the time series into fixations and saccades and to compute dwell time and regression events over an utterance region;
a counter store configured to maintain, within a sliding time window, a revisit count to a displayed question without a user response and a reread count of a displayed statement based on the mapped samples;
a confidence gate and a false-positive filter configured to reject events that fail a confidence threshold or exceed a false-positive score;
a trigger decision component configured, responsive to the counts satisfying thresholds and the confidence/false-positive gates, to assert an assistance signal;
an assistance prompt generator configured to generate an assistance prompt targeted to the corresponding utterance, the assistance prompt offering at least one of: a clarification, a rephrased version, an example, step-by-step guidance, or additional detail;
a presentation component configured to present the assistance prompt in the chat interface as an inline chip or an expanded card anchored to the implicated utterance; and
an adaptation component configured to receive user input to the assistance prompt and to adapt subsequent assistant output according to the user input.

12. The system of claim 11, further comprising a personalization model configured to personalize the first and second thresholds per user based on a population prior and outcomes of prompt acceptances and declines, and to tune at least one of: minimum dwell, cool-down interval, and variant selection between the inline chip and the expanded card.

13. The system of claim 11, wherein the gaze-UI mapper is further configured to associate gaze samples to time-aligned token spans within an utterance to distinguish rereads of different portions of the utterance.

14. The system of claim 11, wherein the presentation component is further configured to apply a per-utterance cool-down after a declined prompt to reduce prompt fatigue.

15. The system of claim 11, wherein the trigger decision component asserts the assistance signal only when a tracker confidence is at least C and a false-positive score computed from at least one of overscroll velocity, pointer-movement jitter, head-pose deviation, or sample dispersion is at most F.

16. The system of claim 11, further comprising a calibration subsystem configured to (i) execute a quick multi-point calibration with a quality indicator and accept/skip controls, (ii) execute a full calibration with residual error estimation, and (iii) apply runtime corrections including head-pose compensation, distance scaling, screen/DPI profile, and planar homography with post-fit validation.

17. The system of claim 11, wherein the adaptation component is further configured to automatically switch to a simplified reading level and to increase font size or contrast when the reread count exceeds a threshold.

18. The system of claim 11, further comprising a proxy aggregator configured, when gaze signals are unavailable or below confidence, to detect look-back proxies including pointer-hover dwell over an utterance region, scroll regressions into the utterance region, and text copy/select events, to emit synthetic fixation and synthetic regression events, and to drive the counter store based on proxy thresholds.

19. The system of claim 11, wherein a gaze estimation module executes on-device and a privacy module is configured to transmit only derived features comprising fixation spans, reread counts, and revisit counts while discarding raw video frames post-inference.

20. The system of claim 11, further comprising a continuity component configured to persist gaze-labeled context such that, upon transferring the session to a second device, an assistance prompt associated with an implicated utterance is re-issued in a format adapted to the second device.

21. The system of claim 11, further comprising scoped connectors to external APIs configured to retrieve domain definitions or examples for inclusion in the assistance prompt, the connectors operating under a privacy & consent module and caching selected materials in an interaction data store for low-latency generation.

22. The system of claim 11, wherein the counter store is configured to reset counts upon at least one of: a user response to the implicated utterance, a scroll beyond a threshold distance, or a chat user-interface state change.

23. The system of claim 11, wherein the false-positive filter is configured to reject events associated with at least one of: rapid overscroll, accidental text selection, or pointer flicks.

24. The system of claim 11, wherein the trigger decision component enforces a per-thread prompt budget and the presentation component exposes a “don't show for this message” control that suppresses re-prompting for the implicated utterance for a cool-down interval.
